(19) United States
(12) Patent Application Publication
(10) Pub. No.: US 2014/0177020 A1
(43) Pub. Date: Jun. 26, 2014

(54) ACTUATOR, LIGHT SCANNER, IMAGE DISPLAY DEVICE, AND HEAD MOUNTED DISPLAY

(71) Applicant: SEIKO EPSON CORPORATION, Tokyo (JP)

(72) Inventors: Makiko HINO, Matsumoto-shi (JP); Yasushi MIZOGUCHI, Suwa-shi (JP)

(73) Assignee: SEIKO EPSON CORPORATION, Tokyo (JP)

(21) Appl. No.: 14/132,495

(22) Filed: Dec. 18, 2013

(30) Foreign Application Priority Data
Dec. 21, 2012 (JP) 2012-279066

(51) Int. Cl. G02B 26/10

(52) U.S. Cl. CPC G02B 26/105
USPC 359/200.1

(57) ABSTRACT

An actuator includes: a movable section; a first shaft section adapted to swingably support the movable section around a first axis; and a reflecting section including a reflecting plate having a reflecting surface adapted to reflect light, and a support rod disposed on a surface of the reflecting plate on an opposite side to the reflecting surface, the support rod being fixed to the movable section, wherein a rib is provided to the surface of the reflecting plate on the opposite side to the reflecting surface.

### BACKGROUND

1. Technical Field

The present invention relates to an actuator, alight scanner, an image display device, and a head mounted display.

2. Related Art

In the past, there has been known an optical device provided with an attachment section having a plate-like shape, a shaft section for supporting the attachment section, a magnet disposed on one surface of the attachment section, and a light reflecting member disposed on the other surface of the attachment section (see, e.g., JP-A-2010-217648).

However, the optical device described above has a problem that the light reflecting member is deflected when swinging the light reflecting member around a predetermined axis.

### SUMMARY

An advantage of some aspects of the invention is to solve at least a part of the problems described above, and the invention can be implemented as the following aspects or application examples.

### APPLICATION EXAMPLE 1

This application example is directed to an actuator including a movable section, a first shaft section adapted to swingably support the movable section around a first axis, and a reflecting section including a reflecting plate having a reflecting surface adapted to reflect light, and a support rod disposed on a surface of the reflecting plate on an opposite side to the reflecting surface, the support rod being fixed to the movable section, and a rib is provided to the surface of the reflecting plate on the opposite side to the reflecting surface.

According to this configuration, when the reflecting section swings due to the swinging movement of the movable section, the deflection of the reflecting plate can be suppressed due to the rib disposed on the surface of the reflecting plate on the opposite side to the reflecting surface. Thus, it is possible to make the reflecting plate act stably.

### APPLICATION EXAMPLE 2

This application example is directed to the actuator according to the application example described above, wherein the rib has a circular shape centered on the support rod.

According to this configuration, when the reflecting section swings due to the swinging movement of the movable section, the deflection of the reflecting plate can be suppressed due to the rib having a circular shape disposed on the surface of the reflecting plate on the opposite side to the reflecting surface. Thus, it is possible to make the reflecting plate act stably.

### APPLICATION EXAMPLE 3

This application example is directed to the actuator according to the application example described above, wherein the rib has a fan-like shape including a circular arc centered on the support rod.

According to this configuration, when the reflecting section swings due to the swinging movement of the movable section, the deflection of the reflecting plate can be suppressed due to the rib having a fan-like shape disposed on the surface of the reflecting plate on the opposite side to the reflecting surface. Thus, it is possible to make the reflecting plate act stably.

### APPLICATION EXAMPLE 4

This application example is directed to the actuator according to the application example described above, wherein the reflecting plate has a circular shape in a plan view, and the rib is disposed in an area within a half of a radius of the reflecting plate from a center of the support rod on the surface of the reflecting plate on the opposite side to the reflecting surface.

According to this configuration, it is possible to efficiently suppress the deflection of the reflecting plate.

### APPLICATION EXAMPLE 5

This application example is directed to the actuator according to the application example described above, wherein the actuator further includes a rib extending from the area within a half of the radius of the reflecting plate toward an outer circumferential portion of the reflecting plate.

According to this configuration, it is possible to more efficiently suppress the deflection of the reflecting plate.

### APPLICATION EXAMPLE 6

This application example is directed to the actuator according to the application example described above, wherein the rib is disposed symmetrically about the first axis in a plan view from a through-thickness direction of the reflecting plate.

According to this configuration, it is possible to swing the reflecting section around the first shaft section in a balanced manner.

### APPLICATION EXAMPLE 7

This application example is directed to the actuator according to the application example described above, wherein the actuator further includes a movable frame connected to the first shaft section, and having a shape surrounding the movable section, and a second shaft section adapted to swingably support the movable frame around a second axis intersecting with the first axis.

According to this configuration, when the reflecting section swings around the first axis and the second axis, the deflection of the reflecting plate can be suppressed due to the rib disposed on the surface of the reflecting plate on the opposite side to the reflecting surface. Thus, it is possible to make the reflecting plate act stably.

### APPLICATION EXAMPLE 8

This application example is directed to a light scanner including a movable section, a first shaft section adapted to swingably support the movable section around a first axis, and a reflecting section including a reflecting plate having a reflecting surface adapted to reflect light, and a support rod disposed on a surface of the reflecting plate on an opposite side to the reflecting surface, the support rod being fixed to the movable section, and a rib is provided to the surface of the reflecting plate on the opposite side to the reflecting surface.

According to this configuration, when the reflecting section swings due to the swinging movement of the movable section, the deflection of the reflecting plate can be suppressed using the rib disposed on the surface of the reflecting plate on the opposite side to the reflecting surface. Thus, it is possible to make the reflecting plate act stably.

### APPLICATION EXAMPLE 9

This application example is directed to an image display device including an actuator having a movable section, a first shaft section adapted to swingably support the movable section around a first axis, and a reflecting section including a reflecting plate having a reflecting surface adapted to reflect light, and a support rod disposed on a surface of the reflecting plate on an opposite side to the reflecting surface, the support rod being fixed to the movable section, wherein a rib is provided to the surface of the reflecting plate on the opposite side to the reflecting surface, and an irradiation section adapted to irradiate the actuator with the light.

According to this configuration, since the actuator with the reduced deflection of the reflecting plate when swinging is installed, the image quality can be improved.

### APPLICATION EXAMPLE 10

This application example is directed to a head mounted display including an actuator having a movable section, a first shaft section adapted to swingably support the movable section around a first axis, and a reflecting section including a reflecting plate having a reflecting surface adapted to reflect light, and a support rod disposed on a surface of the reflecting plate on an opposite side to the reflecting surface, the support rod being fixed to the movable section, wherein a rib is provided to the surface of the reflecting plate on the opposite side to the reflecting surface, and an irradiation section adapted to irradiate the actuator with the light.

According to this configuration, since the actuator with the reduced deflection of the reflecting plate when swinging is installed, the image quality can be improved.

### BRIEF DESCRIPTION OF THE DRAWINGS

The invention will be described with reference to the accompanying drawings, wherein like numbers reference like elements.

FIGS. 1A and 1B are schematic diagrams showing a configuration of a light scanner according to a first embodiment of the invention.

FIG. 2 is a plan view of a reflecting section according to the first embodiment and a second embodiment of the invention.

FIGS. 3A and 3B are schematic diagrams showing a configuration of a light scanner according to the second embodiment of the invention.

FIG. 4 is a block diagram showing a configuration of a voltage applying section.

FIGS. 5A and 5B are explanatory diagrams showing an example of generated voltages.

FIGS. 6A and 6B are schematic diagrams showing a configuration of a light scanner according to a third embodiment of the invention.

FIG. 7 is a plan view of a reflecting section according to the third embodiment and a fourth embodiment of the invention.

FIGS. 8A and 8B are schematic diagrams showing a configuration of a light scanner according to the fourth embodiment of the invention.

FIG. 9 is a schematic diagram showing a configuration of an image display device.

FIG. 10 is a schematic diagram showing a configuration of a portable image display device.

FIG. 11 is a schematic diagram showing a configuration of a head-up display.

FIG. 12 is a schematic diagram showing a configuration of a head mounted display.

FIG. 13 is a plan view of a reflecting section according to a modified example 1.

FIG. 14 is a plan view of a reflecting section according to a modified example 2.

FIG. 15 is a plan view of a reflecting section according to a modified example 3.

FIGS. 16A and 16B are schematic diagrams showing a configuration of a light scanner according to a modified example 4.

### DESCRIPTION OF EXEMPLARY EMBODIMENTS

Some embodiments of the invention will hereinafter be explained with reference to the accompanying drawings. It should be noted that in each of the following drawings, the scale sizes of the members and so on are made different from actual ones in order to express the members and so on to have recognizable dimensions.

### First Embodiment

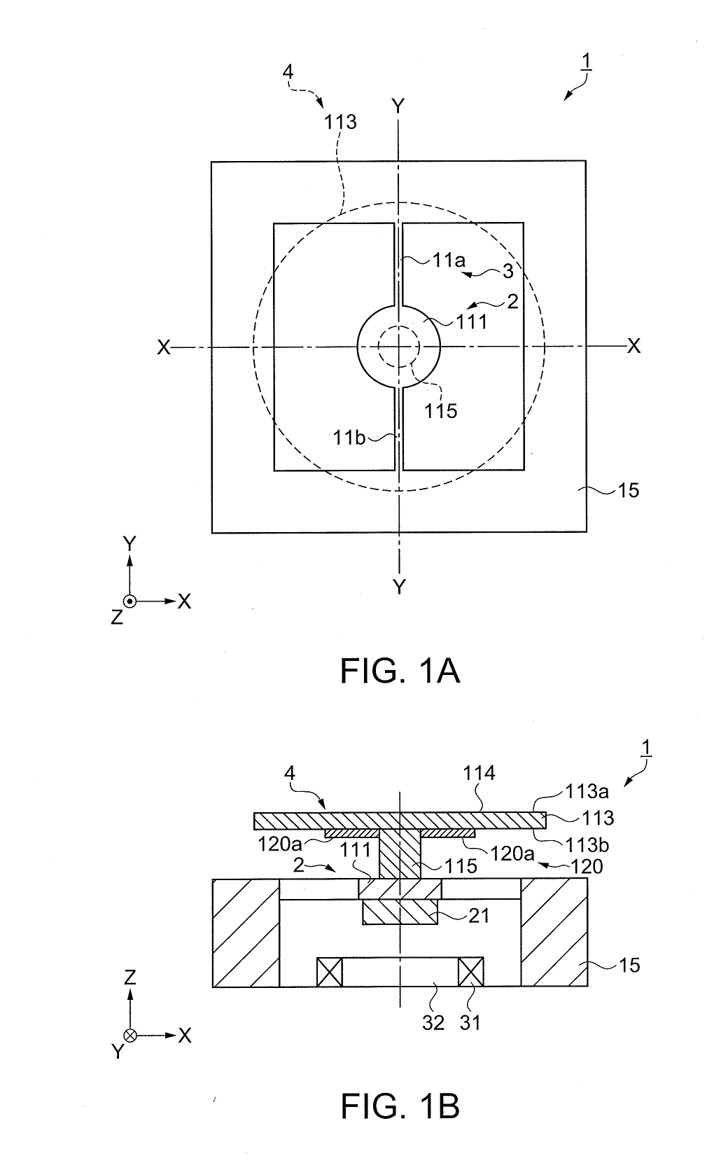

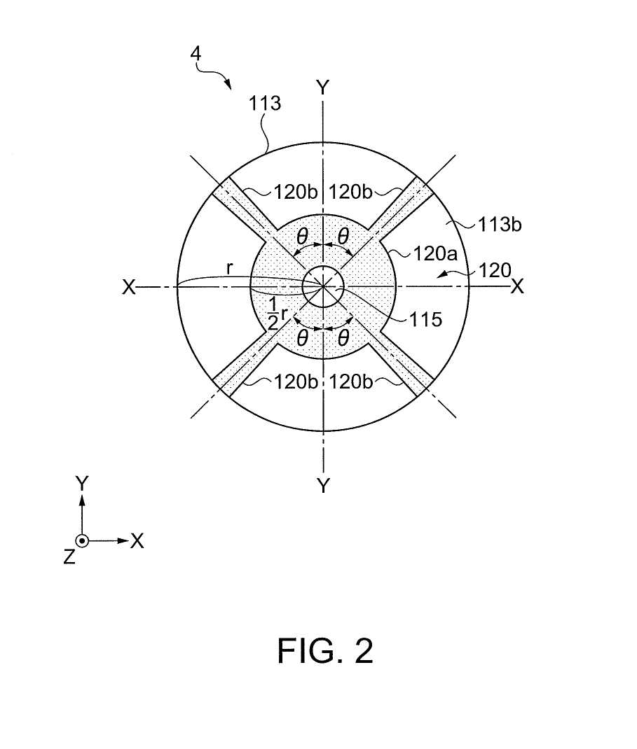

Firstly, a configuration of an actuator will be explained. It should be noted that in the present embodiment, the explanation will be presented citing a light scanner, as an actuator, as an example. The light scanner has a movable section, a first shaft section, and a reflecting section. The first shaft section supports the movable section swingably around a first axis. The reflecting section is provided with a reflecting plate and a support rod. The reflecting plate has a reflecting surface. The support rot is disposed on a surface of the reflecting plate, and the surface is located on an opposite side to the reflecting surface. The support rod is fixed to the movable section. The surface of the reflecting plate on the opposite side to the reflecting surface is provided with at least one rib. FIGS. 1A and 1B show a configuration of the light scanner according to the present embodiment, wherein FIG. 1A is a plan view, and FIG. 1B is an X-X cross-sectional view in FIG. 1A. It should be noted that FIG. 1A is a plan view viewed through the reflecting section. Further, FIG. 2 is a plan view of the reflecting section. Hereinafter, the specific explanation will be presented.

The movable section 2 of the light scanner 1 includes a movable plate 111, and a shaft section 3 includes a pair of shaft sections (first shaft sections) 11a, 11b. Further, an outer frame support section 15 is disposed so as to surround the periphery of the movable plate 111 when viewed from through-thickness direction of the movable plate 111, and the movable plate 111 is connected to the outer frame support section 15 via the shaft sections 11a, 11b. The shaft sections 11a, 11b can elastically be deformed. Further, the movable plate 111 and the outer frame support section 15 are connected to each other via the shaft sections 11a, 11b so that the movable plate 111 becomes swingable (rotatable) around the first axis (around a Y axis in the present embodiment).

The shaft sections 11a, 11b are disposed so as to be opposed to each other via the movable plate 111. Further, the shaft sections 11a, 11b each have an elongated shape extending in a direction along the Y axis. Further, the shaft sections 11a, 11b each have one end portion connected to the movable plate 111, and the other end portion connected to the outer frame support section 15. Further, the shaft sections 11a, 11b are each disposed so that the center axis and the Y axis coincide with each other. The shaft sections 11a, 11b configured in such a manner as described above are each torsionally deformed due to the swinging movement of the movable plate 111 around the Y axis. It should be noted that the configuration of the shaft sections 11a, 11b is not limited to the configuration described above. For example, a meander shape having flexion or curvature at least at one place in the middle can also be provided. Further, the number of the shaft sections 11a, 11b can be singular or plural. The movable plate 111, the shaft sections 11a, 11b, and the outer frame support section 15 are formed integrally using, for example, a silicon single crystal substrate.

The reflecting section 4 is provided with a reflecting plate 113 and a support rod 115. The reflecting plate 113 of the present embodiment forms a plate-like shape, and at the same time, forms a circular shape in a plan view (hereinafter also referred to simply as a “plan view”) viewed from the through-thickness direction of the reflecting plate 113. It should be noted that the shape of the reflecting plate 113 in the plan view can also be an elliptical shape. In the case in which the reflecting plate 113 has an elliptical shape, the X-axis direction can be set to a short-axis direction or a long-axis direction. On a first surface 113a of the reflecting plate 113, there is formed the reflecting surface 114 for reflecting light. Further, on a second surface 113b of the reflecting plate 113, which is a surface opposite to the first surface 113a, there is formed the support rod 115. Further, a surface of the support rod 115 located on an opposite side to the reflecting plate 113 side and the movable plate 111 are fixed to each other. As the fixing method, it is possible to use a method of using a bonding material such as a variety of types of adhesives or brazing materials. As described above, in the present embodiment, the movable plate 111 and the reflecting plate 113 are formed as separate members. By adopting such a configuration, the size of the reflecting section 4 can be kept without being affected by the miniaturization of the movable plate 111 and so on. Further, since in the configuration, the movable plate 111 and the reflecting plate 113 are separated from each other, the reflecting plate 113 is not directly connected to side surfaces of the shaft sections 11a, 11b. Therefore, it is possible to prevent or inhibit the stress due to the torsional deformation of the shaft sections 11a, 11b from affecting the reflecting plate 113 when the reflecting plate 113 swings (rotates). The reflecting plate 113 and the support rod 115 are formed integrally using a substrate made of a silicon single crystal. It should be noted that it is also possible to form the reflecting plate 113 and the support rod 115 separately from each other, and then bond the reflecting plate 113 and the support rod 115 to each other.

Further, the second surface 113b of the reflecting plate 113 is provided with ribs 120. The ribs 120 are each a part having a thickness larger than the thickness of other parts for suppressing the deflection of the reflecting plate 113 when the reflecting section 4 swings, and are also called a so-called reinforcement rib. Further, the reflecting plate 113 has thick portions provided with the rib 120 and thin portions not provided with the rib 120. This is synonymous with the fact that thin portions provided with a groove and thick portions not provided with the groove are provided to the reflecting plate 113.

As shown in FIG. 2, in the present embodiment, the second surface 113b of the reflecting plate 113 of the reflecting section 4 is provided with a rib 120a having a circular shape centered on the support rod 115. Further, the rib 120a is disposed in an area of the second surface 113b of the reflecting plate 113 within a half of a radius r of the reflecting plate 113 from the center of the support rod 115. It should be noted that in the case in which the reflecting plate 113 has the elliptical shape, the rib 120a is disposed inside an elliptical shape taking a half of the long radius of the reflecting plate 113 as the long radius, and a half of the short radius of the reflecting plate 113 as the short radius in the plan view.

Further, in the present embodiment, there are disposed ribs 120b each partially extending from the area within the half of the radius r of the reflecting plate 113 toward the outer circumferential portion of the reflecting plate 113. Each of the ribs 120b extending toward the outer circumferential portion can be disposed within a range of θ=0° through 90° with respect to the swing axis (the Y axis). In the present embodiment, the ribs 120b are each disposed at a position corresponding to θ=45° with respect to the swing axis (the Y axis). Further, the ribs 120 (120a, 120b) are disposed so as to be symmetric about a predetermined axis (the Y axis) in the plan view. It should be noted that hatching is provided in FIG. 2 so as to make the layout of the ribs 120 easy to understand.

Further, as shown in FIG. 1A, the reflecting plate 113 is disposed so as to cover the movable plate 111 and the shaft sections 11a, 11b in the plan view. Therefore, it is possible to increase the area of the reflecting section 4 while decreasing the distance between the shaft sections 11a, 11b. Further, since the distance between the shaft sections 11a, 11b can be decreased, miniaturization of the outer frame support section 15 can be achieved. Thus, it becomes possible to miniaturize the overall structure of the light scanner 1 while keeping the area of the reflecting plate 113 large. Further, it is possible to prevent unwanted light from being reflected by the movable plate 111 and the shaft sections 11a, 11b and from becoming stray light. Further, it is preferable that an antireflection treatment is provided to the surface of the outer frame support section 15. Thus, it is possible to prevent the unwanted light applied to the outer frame support section 15 from becoming the stray light. Such an antireflection treatment is not particularly limited, but there can be cited, for example, formation of an antireflection film (a dielectric multilayer film), a surface roughening process, and a blackening process. It should be noted that the antireflection treatment can also be provided to the surfaces of the movable plate 111 and the shaft sections 11a, 11b besides the outer frame support section 15.

A permanent magnet 21 is bonded to a surface of the movable plate 111 on an opposite side to the surface fixed to the support rod 115 via an adhesive or the like. Further, the permanent magnet 21 is magnetized into an N pole and an S pole in a direction (the X axis direction) perpendicular to a predetermined axis (the Y axis) in the plan view. In other words, the permanent magnet 21 has a pair of magnetic poles opposed to each other across the Y axis and having respective polarities different from each other.

A coil 31 is disposed below the permanent magnet 21. In other words, the coil 31 is disposed so as to be opposed to the permanent magnet 21. In the present embodiment, the coil 31 is wound around the outer circumference of a magnetic core 32. Further, the coil 31 is electrically connected to a voltage applying device (not shown).

Then, an operation method of the light scanner 1 will be explained. Firstly, the voltage applying device supplies the coil 31 with an alternating current having a predetermined frequency. In response to the current supplied, the coil 31 alternately generates a magnetic field directed upward (on the movable plate 111 side) and a magnetic field directed downward. Thus, one of the pair of magnetic poles of the permanent magnet 21 comes closer to the coil 31 while the other of the pair of magnetic poles moves away from the coil 31. In such a manner as described above, the movable plate 111, and the reflecting section 4 and the permanent magnet 21 fixed to the movable plate 111 swing around the Y axis as the predetermined axis while causing the torsional deformation of the shaft sections 11a, 11b.

It should be noted that the predetermined frequency of the alternating current to be supplied to the coil 31 is preferably set so as to be approximately equal to the frequency (the torsional resonance frequency) of a vibration system constituted by the reflecting section 4, the shaft sections 11a, 11b, and the permanent magnet 21. By making use of the resonance as described above, a large deflection angle can be obtained with a little power consumption when swinging the movable plate 111 around the predetermined axis (the Y axis).

It should be noted that although the drive system using the electromagnetic force between the permanent magnet 21 and the coil 31 is shown in the present embodiment, the system is not limited thereto, but it is sufficient for the system to be configured so as to generate a drive force between the permanent magnet 21 corresponding to a ferromagnet and the coil 31 corresponding to a magnetic field generator and the power supply. For example, a so-called moving-coil drive system having the coil 31 provided to the movable plate 111 can also be adopted.

As described above, according to the first embodiment, the following advantage can be obtained.

Since the second surface 113b of the reflecting plate 113 is provided with the rib 120a centered on the support rod 115 and the ribs 120b each extending from the central portion of the reflecting plate 113 toward the outer peripheral direction of the reflecting plate 113, the deflection of the reflecting plate 113 can be suppressed when the reflecting plate 113 is swung due to the swinging movement of the movable plate 111.

### Second Embodiment

Then, a configuration of an actuator according to a second embodiment will be explained. It should be noted that in the present embodiment, the explanation will be presented citing a light scanner, as an actuator, as an example. The light scanner according to the present embodiment has a movable section, a first shaft section, and a reflecting section. The first shaft section supports the movable section swingably around a first axis. The reflecting section is provided with a reflecting plate and a support rod. The reflecting plate has a reflecting surface. The support rot is disposed on a surface of the reflecting plate, and the surface is located on an opposite side to the reflecting surface. The support rod is fixed to the movable section. The surface of the reflecting plate of the reflecting section on the opposite side to the reflecting surface is provided with at least one rib. Further, the light scanner 1a according to the present embodiment includes a movable frame and a second shaft section. The movable frame is connected to the first shaft section, and has a frame-like shape surrounding the movable section. The second shaft section swingably supports the movable frame around a second axis intersecting with the first axis.

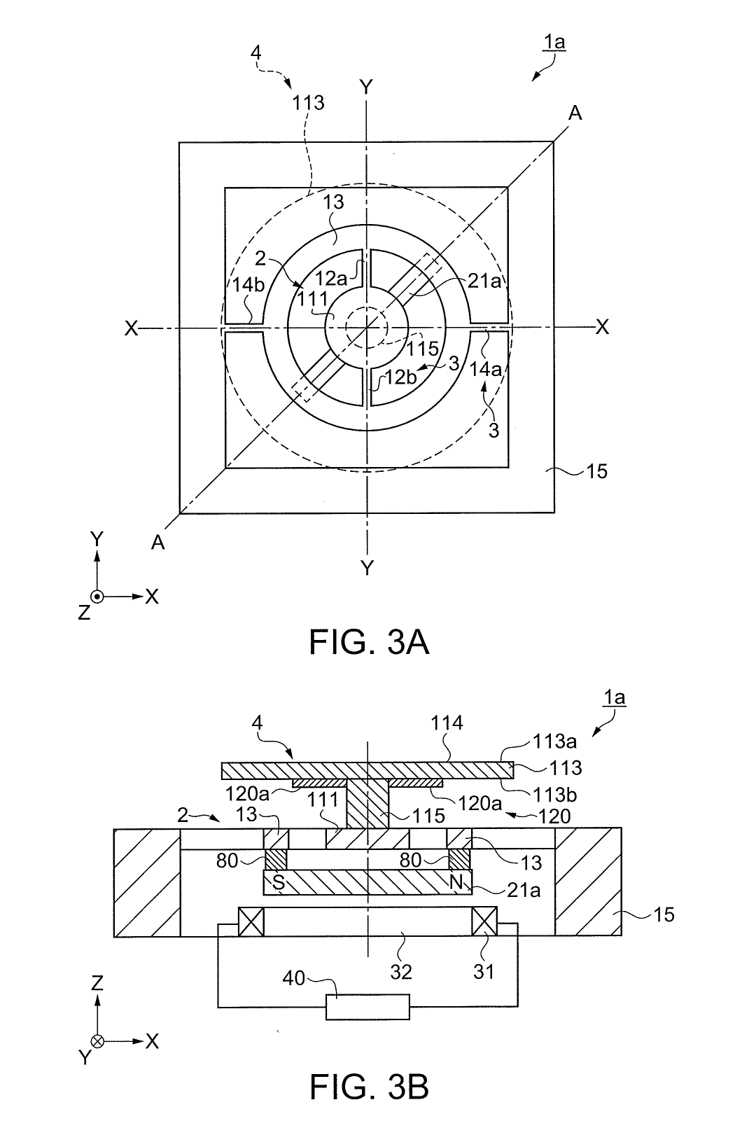

FIGS. 3A and 3B are schematic diagrams showing a configuration of the light scanner according to the present embodiment, wherein FIG. 3A is a plan view viewed through the reflecting section, and FIG. 3B is an A-A cross-sectional view in FIG. 3A. It should be noted that the same components and so on as those in the first embodiment are denoted with the same reference symbols. Further, since the configuration of the reflecting section 4 according to the present embodiment is substantially the same as in the first embodiment, the explanation of the reflecting section 4 will be omitted (see FIG. 2). Hereinafter, the specific explanation will be presented.

The movable section 2 of the light scanner 1a according to the present embodiment includes the movable plate 111, and the shaft section 3 includes a pair of first shaft sections 12a, 12b. As shown in FIG. 3A, the movable plate 111 has a circular shape in the plan view, and is disposed in a central portion of the light scanner 1a. The movable frame 13 has a frame-like shape, and is disposed so as to surround the periphery of the movable plate 111 when viewed from the through-thickness direction of the movable plate 111. In other words, the movable plate 111 is disposed inside the movable frame 13 having a frame-like shape. Further, the movable plate 111 is connected to the movable frame 13 via the first shaft sections 12a, 12b.

The outer frame support section 15 has a frame-like shape, and is disposed so as to surround the periphery of the movable frame 13 when viewed from the through-thickness direction of the movable plate 111. In other words, the movable frame 13 is disposed inside the outer frame support section 15. The movable frame 13 is connected to the outer frame support section 15 via the second shaft sections 14a, 14b.

The first shaft sections 12a, 12b and the second shaft sections 14a, 14b are each elastically deformable. Further, the first shaft sections 12a, 12b connect the movable plate 111 and the movable frame 13 to each other so as to make the movable plate 111 rotatable (swingable) around the first axis (around the Y axis in the present embodiment). Further, the second shaft sections 14a, 14b connect the movable frame 13 and the outer frame support section 15 to each other so as to make the movable frame 13 rotatable (swingable) around the second axis (around the X axis in the present embodiment) perpendicular to the first axis.

The first shaft sections 12a, 12b are disposed so as to be opposed to each other via the movable plate 111. Further, the first shaft sections 12a, 12b each have an elongated shape extending in a direction along the Y axis. Further, the first shaft sections 12a, 12b each have one end portion connected to the movable plate 111, and the other end portion connected to the movable frame 13. Further, the first shaft sections 12a, 12b are each disposed so that the center axis and the Y axis coincide with each other. The first shaft sections 12a, 12b configured in such a manner as described above are each torsionally deformed due to the swinging movement of the movable plate 111 around the Y axis.

The second shaft sections 14a, 14b are disposed so as to be opposed to each other via the movable frame 13. Further, the second shaft sections 14a, 14b each have an elongated shape extending in a direction along the X axis. Further, the second shaft sections 14a, 14b each have one end portion connected to the movable frame 13, and the other end portion connected to the outer frame support section 15. The entire second shaft sections 14a, 14b configured in such a manner as described above are each torsionally deformed due to the swinging movement of the movable frame 13 around the X axis. By arranging that the movable plate 111 can swing around the Y axis, and at the same time, the movable frame 13 can swing around the X axis as described above, the swing (rotational) movement around the two axes, namely the X axis and the Y axis, is possible.

It should be noted that the configurations of the first shaft sections 12a, 12b and the second shaft sections 14a, 14b are not limited to the configurations described above. For example, a meander shape having flexion or curvature at least at one place in the middle can also be provided. Further, the number of the first shaft sections 12a, 12b and the second shaft sections 14a, 14b can be singular or plural. It should be noted that the movable plate 111, the movable frame 13, the first shaft sections 12a, 12b, the second shaft sections 14a, 14b, and the outer frame support section 15 are formed integrally using, for example, a silicon single crystal substrate.

As shown in FIG. 3A, the reflecting plate 113 of the reflecting section 4 is formed so as to cover the movable section 2 in the plan view. In other words, the movable plate 111, the first shaft sections 12a, 12b, the movable frame 13, and the second shaft sections 14a, 14b are disposed inside the reflecting plate 113 in the plan view. Therefore, it is possible to increase the area of the reflecting plate 113 while decreasing the distance between the first shaft sections 12a, 12b. Further, since it is possible to decrease the distance between the first shaft sections 12a, 12b, miniaturization of the movable frame 13 can be achieved. Further, since the miniaturization of the movable frame 13 can be achieved, it is possible to decrease the distance between the second shaft sections 14a, 14b. Thus, it becomes possible to miniaturize the overall structure of the light scanner 1a while keeping the area of the reflecting plate 113 large. Further, it is possible to prevent unwanted light from being reflected by the movable plate 111, the first shaft sections 12a, 12b, the movable frame 13, and the second shaft sections 14a, 14b and from becoming the stray light. Further, it is preferable that an antireflection treatment is provided to the surface of the outer frame support section 15. Thus, it is possible to prevent the unwanted light applied to the outer frame support section 15 from becoming the stray light. Such an antireflection treatment is not particularly limited, but there can be cited, for example, formation of an antireflection film (a dielectric multilayer film), a surface roughening process, and a blackening process. It should be noted that the antireflection treatment can also be provided to the surfaces of the movable plate 111, the first shaft sections 12a, 12b, the movable frame 13, and the second shaft sections 14a, 14b besides the outer frame support section 15.

A permanent magnet 21a is disposed so as to be opposed to a surface of the movable plate 111 on an opposite side to the surface fixed to the support rod 115. The permanent magnet 21a has an elongated shape, and is bonded to one surface of the movable frame 13 via a spacer 80. An adhesive or the like is applied to the bonding between the movable frame 13 and the spacer 80, and the bonding between the spacer 80 and the permanent magnet 21a. By making the spacer 80 intervene between the movable frame 13 and the permanent magnet 21a, a space is formed between the movable plate 111 and the permanent magnet 21a. Further, due to the formation of the space, it is possible to prevent the interference between the movable plate 111 and the permanent magnet 21a when swinging the movable plate 111.

The coil 31 is disposed below the permanent magnet 21a. In other words, the coil 31 is disposed so as to be opposed to the permanent magnet 21a. In the present embodiment, the coil 31 is wound around the outer circumference of the magnetic core 32. Further, the coil 31 is electrically connected to a voltage applying section 40.

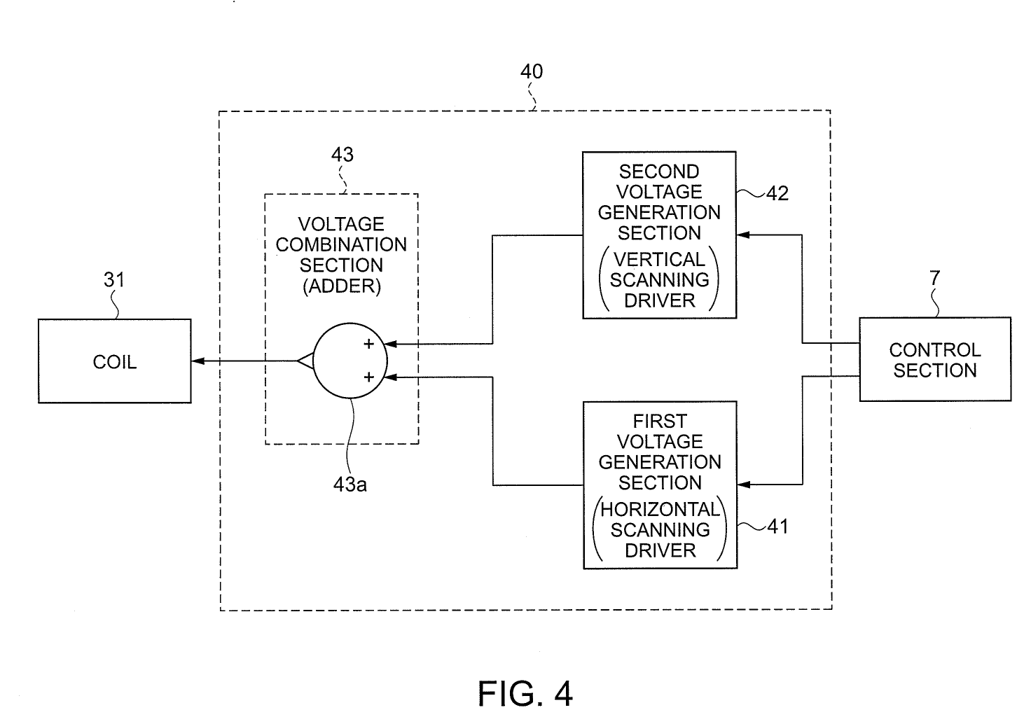

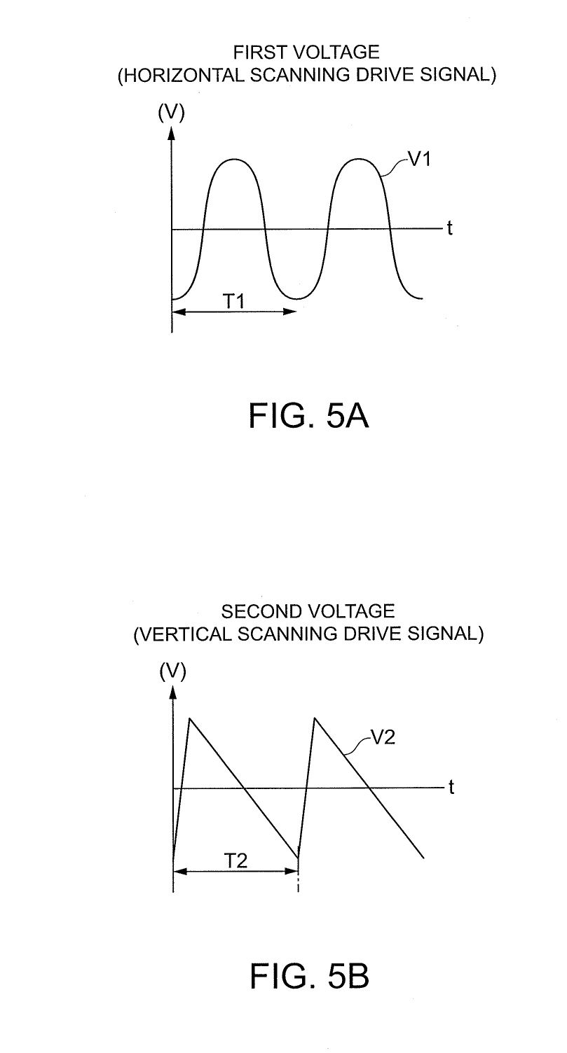

Then, a configuration of the voltage applying section 40 will be explained. FIG. 4 is a block diagram showing a configuration of the voltage applying section 40, and FIGS. 5A and 5B are explanatory diagrams showing an example of generated voltages.

As shown in FIG. 4, the voltage applying section 40 is provided with a first voltage generation section 41 for generating a first voltage V1 for swinging the movable plate 111 around the Y axis, a second voltage generation section 42 for generating a second voltage V2 for swinging the movable plate 111 around the X axis, and a voltage combination section 43 for combining the first voltage V1 and the second voltage V2 with each other. The first voltage generation section 41 and the second voltage generation section 42 of the voltage applying section 40 are each connected to a control section 7. Further, the voltage applying section 40 is electrically connected to the coil 31, and is configured so as to apply the voltage combined by the voltage combination section 43 to the coil 31.

As shown in FIG. 5A, the first voltage generation section 41 is for generating the first voltage V1 (a horizontal scanning voltage) periodically varying with a period T1. In other words, the first voltage generation section 41 is for generating the first voltage V1 with a first frequency (1/T1). The first voltage V1 has a sinusoidal waveform. Therefore, the light scanner 1a can effectively perform the main scanning of the light. It should be noted that the waveform of the first voltage V1 is not limited thereto.

Further, the first frequency (1/T1) is not particularly limited providing the frequency is suitable for the horizontal scanning, but is preferably in a range of 10 through 40 kHz. In the present embodiment, the first frequency is set to be equal to a torsional resonance frequency (f1) of a first vibration system (a torsional vibration system) constituted by the movable plate 111 and the first shaft sections 12a, 12b. In other words, the first vibration system is designed (manufactured) so that the torsional resonance frequency f1 becomes a frequency suitable for the horizontal scanning. Thus, it is possible to enlarge the rotational angle of the movable plate 111 around the Y axis.

Incidentally, as shown in FIG. 5B, the second voltage generation section 42 is for generating the second voltage V2 (a vertical scanning voltage) periodically varying with a period T2 different from the period T1. In other words, the second voltage generation section 42 is for generating the second voltage V2 with a second frequency (1/T2). The second voltage V2 has a saw-tooth waveform. Therefore, the light scanner 1a can effectively perform the vertical scanning (sub-scanning) of the light. It should be noted that the waveform of the second voltage V2 is not limited thereto.

The second frequency (1/T2) is not particularly limited providing the frequency is different from the first frequency (1/T1), and is suitable for the vertical scanning, but is preferably in a range of 30 through 120 Hz. Further, roughly 60 Hz is more preferable. By setting the frequency of the second voltage V2 to roughly 60 Hz and setting the frequency of the first voltage V1 in a range of 10 through 40 kHz as described above, it is possible to rotate the movable plate 111 around each of the two axes (the X axis and the Y axis) perpendicular to each other at frequencies suitable for the drawing in the display. However, if the movable plate 111 can be rotated around each of the X axis and the Y axis, the combination of the frequency of the first voltage V1 and the frequency of the second voltage V2 is not particularly limited.

In the present embodiment, the frequency of the second voltage V2 is adjusted to be a frequency different from the torsional resonance frequency (the resonance frequency) of a second vibration system (a torsional vibration system) constituted by the movable plate 111, the first shaft sections 12a, 12b, the movable frame 13, and the second shaft sections 14a, 14b. It is preferable that such a frequency (second frequency) of the second voltage V2 is lower than the frequency (the first frequency) of the first voltage V1. In other words, it is preferable that the period T2 is longer than the period T1. Thus, it is possible to more surely and more smoothly rotate the movable plate 111 around the X axis at the second frequency while rotating the movable plate 111 around the Y axis at the first frequency.

Further, assuming that the torsional resonance frequency of the first vibration system is f1 [Hz], and the torsional resonance frequency of the second vibration system is f2 [Hz], f1 and f2 preferably fulfill the relationship of f2<f1, and more preferably fulfill the relationship of f1 ≧10f2. Thus, it is possible to more smoothly rotate the movable plate 111 around the X axis at the frequency of the second voltage V2 while rotating the movable plate 111 around the Y axis at the frequency of the first voltage V1.

Such a first voltage generation section 41 and such a second voltage generation section 42 are driven based on the signals from the control section 7 connected to the respective voltage generation sections. Further, the first voltage generation section 41 and the second voltage generation section 42 are each connected to the voltage combination section 43. The voltage combination section 43 is provided with an adder 43a for applying the voltage to the coil 31. The adder 43a receives the first voltage V1 from the first voltage generation section 41, and at the same time, receives the second voltage V2 from the second voltage generation section 42, then combines these voltages, and then applies the result to the coil 31.

Then, an operation of the light scanner 1a will be explained. It should be noted that as described above, in the present embodiment, the frequency of the first voltage V1 is set to be equal to the torsional resonance frequency of the first vibration system, and the frequency of the second voltage V2 is set to a value, which is different from the torsional resonance frequency of the second vibration system, and is lower than the frequency of the first voltage V1 (e.g., the frequency of the first voltage V1 is set to 15 kHz, and the frequency of the second voltage V2 is set to 60 Hz).

Firstly, for example, the first voltage V1 shown in FIG. 5A and the second voltage V2 shown in FIG. 5B are combined in the voltage combination section 43, and then, the voltage thus combined is applied to the coil 31. Then, the current flows through the coil 31 due to the first voltage V1 applied to the coil 31. As a result, due to the Lorentz force caused by the interaction between the magnetic field by the current flowing through the coil 31 and the magnetic field of the permanent magnet 21a, the first shaft sections 12a, 12b torsionally deformed, and thus, the movable plate 111 swings taking the Y axis (the first axis) as the center axis. Further, the frequency of the first voltage V1 is equal to the torsional resonance frequency of the first vibration system. Therefore, the movable plate 111 can efficiently be rotated around the Y axis using the first voltage V1. Therefore, even in the case in which the vibration having the torsional vibration component of the movable frame 13 around the Y axis described above is small, the rotational angle of the movable plate 111 around the Y axis due to the vibration can be increased.

Further, the current flows through the coil 31 due to the second voltage V2 applied to the coil 31. As a result, due to the Lorentz force caused by the interaction between the magnetic field by the current flowing through the coil 31 and the magnetic field of the permanent magnet 21a, the second shaft sections 14a, 14b are torsionally deformed, and thus, the movable frame 13 swings together with the movable plate 111 taking the X axis (the second axis) as the center axis. Further, the frequency of the second voltage V2 is set to be extremely low compared to the frequency of the first voltage V1. Further, the torsional resonance frequency of the second vibration system is designed to be lower than the torsional resonance frequency of the first vibration system. Therefore, the movable plate 111 can be prevented from rotating around the Y axis at the frequency of the second voltage V2.

It should be noted that in the present embodiment, there is described the so-called moving-magnet actuator having the permanent magnet 21a disposed on the movable frame 13. However, the configuration is not limited thereto, but a so-called moving-coil actuator having the coil disposed on the movable frame 13 can also be adopted. Further, in the moving-coil actuator, the coil can be disposed only on the movable frame 13, or can be disposed on both of the movable frame 13 and the movable plate 111.

As described hereinabove, according to the second embodiment described above, the following advantage can be obtained in addition to the advantage of the first embodiment.

When swinging around the first shaft sections 12a, 12b and the second shaft sections 14a, 14b, the deflection of the reflecting plate 113 can be suppressed by the ribs 120a, 120b disposed on the second surface 113b of the reflecting plate 113. Thus, it is possible to make the reflecting plate 113 act stably.

### Third Embodiment

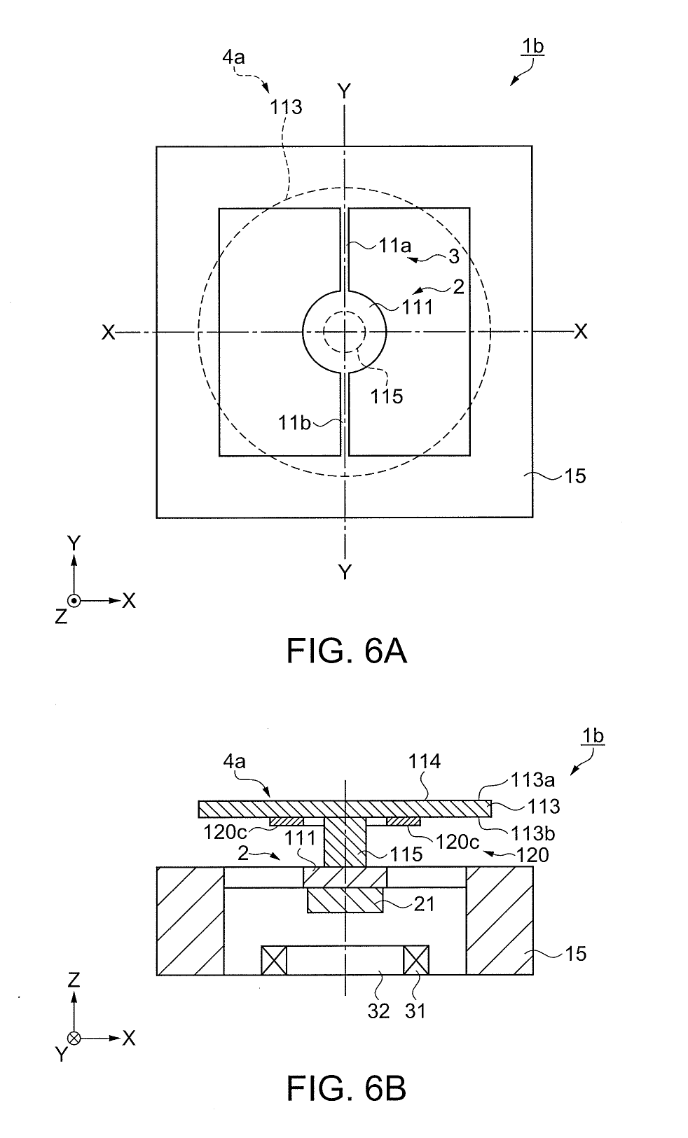

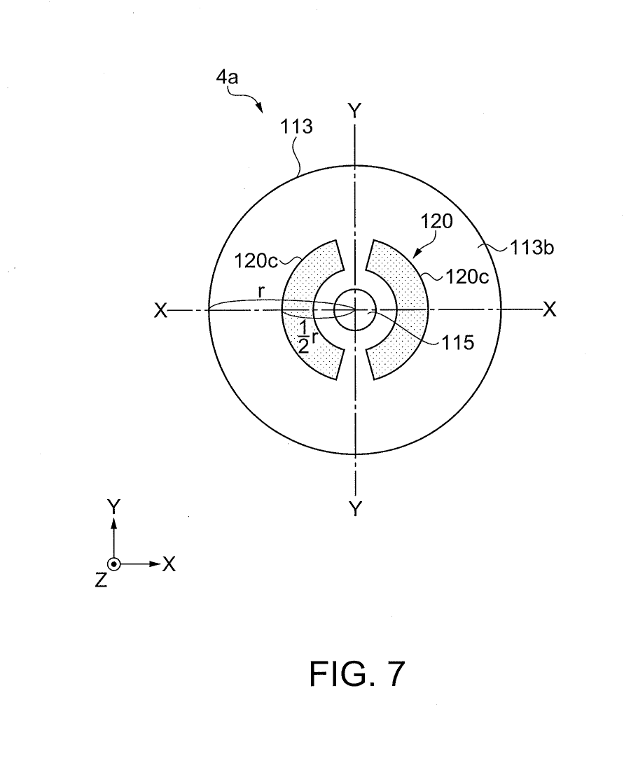

Then, a configuration of an actuator will be explained. It should be noted that in the present embodiment, the explanation will be presented citing a light scanner, as an actuator, as an example. The light scanner has a movable section, a first shaft section, and a reflecting section. The first shaft section supports the movable section swingably around a first axis. The reflecting section is provided with a reflecting plate and a support rod. The reflecting plate has a reflecting surface. The support rot is disposed on a surface of the reflecting plate, and the surface is located on an opposite side to the reflecting surface. The support rod is fixed to the movable section. The surface of the reflecting plate on the opposite side to the reflecting surface is provided with at least one rib. FIGS. 6A and 6B show a configuration of the light scanner according to the present embodiment, wherein FIG. 6A is a plan view, and FIG. 6B is an X-X cross-sectional view in FIG. 6A. It should be noted that FIG. 6A is a plan view viewed through the reflecting section. Further, FIG. 7 is a plan view of the reflecting section. Hereinafter, the specific explanation will be presented. It should be noted that the same components and so on as those in the first embodiment are denoted with the same reference symbols.

The movable section 2 includes the movable plate 111, and the shaft section 3 includes the pair of shaft sections (the first shaft sections) 11a, 11b. Further, the outer frame support section 15 is disposed so as to surround the periphery of the movable plate 111 when viewed from through-thickness direction of the movable plate 111, and the movable plate 111 is connected to the outer frame support section 15 via the shaft sections 11a, 11b. The shaft sections 11a, 11b can elastically be deformed. Further, the movable plate 111 and the outer frame support section 15 are connected to each other via the shaft sections 11a, 11b so that the movable plate 111 becomes swingable (rotatable) around the first axis (around the Y axis in the present embodiment).

The shaft sections 11a, 11b are disposed so as to be opposed to each other via the movable plate 111. Further, the shaft sections 11a, 11b each have an elongated shape extending in a direction along the Y axis. Further, the shaft sections 11a, 11b each have one end portion connected to the movable plate 111, and the other end portion connected to the outer frame support section 15. Further, the shaft sections 11a, 11b are each disposed so that the center axis and the Y axis coincide with each other. The shaft sections 11a, 11b configured in such a manner as described above are each torsionally deformed due to the swinging movement of the movable plate 111 around the Y axis. It should be noted that the configuration of the shaft sections 11a, 11b is not limited to the configuration described above. For example, a meander shape having flexion or curvature at least at one place in the middle can also be provided. Further, the number of the shaft sections 11a, 11b can be singular or plural. The movable plate 111, the shaft sections 11a, 11b, and the outer frame support section 15 are formed integrally using, for example, a silicon single crystal substrate.

A reflecting section 4a is provided with the reflecting plate 113 and the support rod 115. The reflecting plate 113 according to the present embodiment has a plate-like shape, and at the same time, has a circular shape in the plan view. It should be noted that the reflecting plate 113 can also have an elliptical shape. In the case in which the reflecting plate 113 has an elliptical shape, the X-axis direction can be set to a short-axis direction or a long-axis direction. On the first surface 113a of the reflecting plate 113, there is formed the reflecting surface 114 for reflecting light. Further, on the second surface 113b of the reflecting plate 113, which is a surface opposite to the first surface 113a, there is formed the support rod 115. Further, a surface of the support rod 115 located on an opposite side to the reflecting plate 113 side and the movable plate 111 are fixed to each other. As the fixing method, it is possible to use a method of using a bonding material such as a variety of types of adhesives or brazing materials. As described above, in the present embodiment, the movable plate 111 and the reflecting plate 113 are formed as separate members. By adopting such a configuration, the size of the reflecting section 4 can be held without being affected by the miniaturization of the movable plate 111 and so on. Further, since in the configuration, the movable plate 111 and the reflecting plate 113 are separated from each other, the reflecting plate 113 is not directly connected to side surfaces of the shaft sections 11a, 11b. Therefore, it is possible to prevent or inhibit the stress due to the torsional deformation of the shaft sections 11a, 11b from affecting the reflecting plate 113 when the reflecting plate 113 swings (rotates). The reflecting plate 113 and the support rod 115 are formed integrally using a substrate made of a silicon single crystal. It should be noted that it is also possible to form the reflecting plate 113 and the support rod 115 separately from each other, and then bond the reflecting plate 113 and the support rod 115 to each other.

Further, the second surface 113b of the reflecting plate 113 is provided with the ribs 120. The ribs 120 are for suppressing the deflection of the reflecting plate 113 when the reflecting section 4a swings. Further, the reflecting plate 113 has the thick portions provided with the rib 120 and the thin portions not provided with the rib 120. This is synonymous with the fact that the thin portions provided with the groove and the thick portions not provided with the groove are provided to the reflecting plate 113.

As shown in FIG. 7, in the present embodiment, the second surface 113b of the reflecting plate 113 of the reflecting section 4a is provided with ribs 120c each having a fan-like shape including a circular arc centered on the support rod 115. Further, the ribs 120c are disposed in an area of the second surface 113b of the reflecting plate 113 within a half of the radius r of the reflecting plate 113 from the center of the support rod 115. It should be noted that in the case in which the reflecting plate 113 has the elliptical shape, the ribs 120c are disposed inside an elliptical shape taking a half of the long radius of the reflecting plate 113 as the long radius, and a half of the short radius of the reflecting plate 113 as the short radius in the plan view.

Further, in the present embodiment, the pair of ribs 120c are disposed so as to be symmetric about a predetermined axis (the Y axis) in the plan view. Further, the ribs 120c according to the present embodiment are formed in the areas other than an area on the Y axis. In other words, the ribs 120c are formed in the areas not overlapping the shaft sections 11a, 11b in the plan view. It should be noted that hatching is provided in FIG. 7 so as to make the layout of the ribs 120 easy to understand.

Further, as shown in FIG. 6A, the reflecting plate 113 is disposed so as to cover the movable plate 111 and the shaft sections 11a, 11b in the plan view. Therefore, it is possible to increase the area of the reflecting section 4 while decreasing the distance between the shaft sections 11a, 11b. Further, since the distance between the shaft sections 11a, 11b can be decreased, miniaturization of the outer frame support section 15 can be achieved. Thus, it becomes possible to miniaturize the overall structure of the light scanner 1b while keeping the area of the reflecting plate 113 large. Further, it is possible to prevent unwanted light from being reflected by the movable plate 111 and the shaft sections 11a, 11b and from becoming stray light. Further, it is preferable that an antireflection treatment is provided to the surface of the outer frame support section 15. Thus, it is possible to prevent the unwanted light applied to the outer frame support section 15 from becoming the stray light. Such an antireflection treatment is not particularly limited, but there can be cited, for example, formation of an antireflection film (a dielectric multilayer film), a surface roughening process, and a blackening process. It should be noted that the antireflection treatment can also be provided to the surfaces of the movable plate 111 and the shaft sections 11a, 11b besides the outer frame support section 15.

The permanent magnet 21 is bonded to the surface of the movable plate 111 on the opposite side to the surface fixed to the support rod 115 via an adhesive or the like. Further, the permanent magnet 21 is magnetized into an N pole and an S pole in the direction (the X axis direction) perpendicular to the predetermined axis (the Y axis) in the plan view. In other words, the permanent magnet 21 has the pair of magnetic poles opposed to each other across the Y axis and having the respective polarities different from each other.

The coil 31 is disposed below the permanent magnet 21. In other words, the coil 31 is disposed so as to be opposed to the permanent magnet 21. In the present embodiment, the coil 31 is wound around the outer circumference of the magnetic core 32. Further, the coil 31 is electrically connected to the voltage applying device (not shown).

Then, an operation method of the light scanner 1b will be explained. Firstly, the voltage applying device supplies the coil 31 with the alternating current having the predetermined frequency. In response to the current supplied, the coil 31 alternately generates the magnetic field directed upward (on the movable plate 111 side) and the magnetic field directed downward. Thus, one of the pair of magnetic poles of the permanent magnet 21 comes closer to the coil 31 while the other of the pair of magnetic poles moves away from the coil 31. In such a manner as described above, the movable plate 111, and the reflecting section 4 and the permanent magnet 21 fixed to the movable plate 111 swing around the Y axis as the predetermined axis while causing the torsional deformation of the shaft sections 11a, 11b.

It should be noted that the predetermined frequency of the alternating current to be supplied to the coil 31 is preferably set so as to be approximately equal to the frequency (the torsional resonance frequency) of the vibration system constituted by the reflecting section 4, the shaft sections 11a, 11b, and the permanent magnet 21. By making use of the resonance as described above, a large deflection angle can be obtained with a little power consumption when swinging the movable plate 111 around the predetermined axis (the Y axis).

It should be noted that although the drive system using the electromagnetic force between the permanent magnet 21 and the coil 31 is shown in the present embodiment, the system is not limited thereto, but it is sufficient for the system to be configured so as to generate a drive force between the permanent magnet 21 corresponding to the ferromagnet and the coil 31 corresponding to the magnetic field generator and the power supply. For example, the so-called moving-coil drive system having the coil 31 provided to the movable plate 111 can also be adopted.

As described hereinabove, according to the third embodiment, the following advantage can be obtained.

Since the ribs 120c each including the circular arc centered on the support rod 115 are provided to the second surface 113b of the reflecting plate 113, it is possible to suppress the deflection of the reflecting plate 113 when the reflecting plate 113 is swung due to the swinging movement of the movable plate 111.

### Fourth Embodiment

Then, a configuration of an actuator according to a fourth embodiment will be explained. It should be noted that in the present embodiment, the explanation will be presented citing a light scanner, as an actuator, as an example. The light scanner according to the present embodiment has a movable section, a first shaft section, and a reflecting section. The first shaft section supports the movable section swingably around a first axis. The reflecting section is provided with a reflecting plate and a support rod. The reflecting plate has a reflecting surface. The support rot is disposed on a surface of the reflecting plate, and the surface is located on an opposite side to the reflecting surface. The support rod is fixed to the movable section. The surface of the reflecting plate of the reflecting section on the opposite side to the reflecting surface is provided with at least one rib. Further, the light scanner 1c according to the present embodiment includes a movable frame and a second shaft section. The movable frame is connected to the first shaft section, and has a frame-like shape surrounding the movable section. The second shaft section swingably supports the movable frame around a second axis intersecting with the first axis.

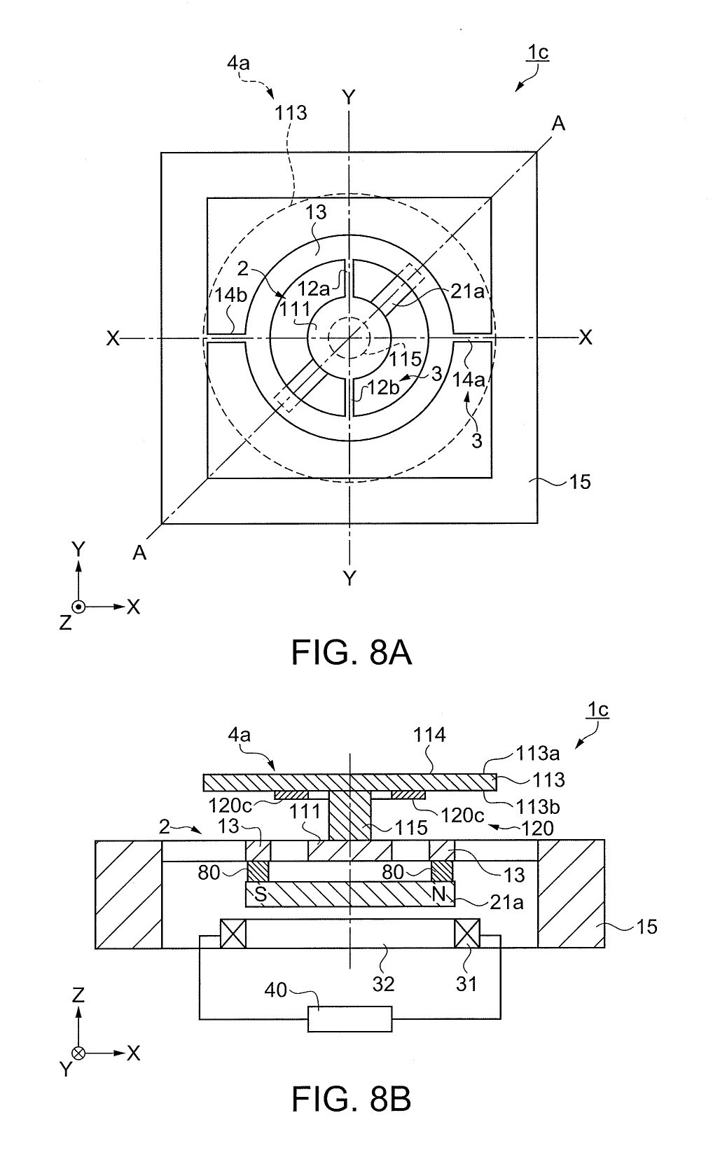

FIGS. 8A and 8B show a configuration of the light scanner according to the present embodiment, wherein FIG. 8A is a plan view viewed through the reflecting section, and FIG. 8B is an A-A cross-sectional view in FIG. 8A. It should be noted that the same components and so on as those in the second embodiment are denoted with the same reference symbols. Further, since the configuration of the reflecting section 4a according to the present embodiment is substantially the same as in the third embodiment, the explanation of the reflecting section 4a will be omitted (see FIG. 7). Hereinafter, the specific explanation will be presented.

The movable section 2 of the present embodiment includes the movable plate 111, and the shaft section 3 includes the pair of first shaft sections 12a, 12b. As shown in FIG. 8A, the movable plate 111 has a circular shape in the plan view, and is disposed in a central portion of the light scanner 1c. The movable frame 13 has a frame-like shape, and is disposed so as to surround the periphery of the movable plate 111 when viewed from the through-thickness direction of the movable plate ill. In other words, the movable plate 111 is disposed inside the movable frame 13 having a frame-like shape. Further, the movable plate 111 is connected to the movable frame 13 via the first shaft sections 12a, 12b.

The outer frame support section 15 has a frame-like shape, and is disposed so as to surround the periphery of the movable frame 13 when viewed from the through-thickness direction of the movable plate 111. In other words, the movable frame 13 is disposed inside the outer frame support section 15. The movable frame 13 is connected to the outer frame support section 15 via the second shaft sections 14a, 14b.

The first shaft sections 12a, 12b and the second shaft sections 14a, 14b are each elastically deformable. Further, the first shaft sections 12a, 12b connect the movable plate 111 and the movable frame 13 to each other so as to make the movable plate 111 rotatable (swingable) around the first axis (around the Y axis in the present embodiment). Further, the second shaft sections 14a, 14b connect the movable frame 13 and the outer frame support section 15 to each other so as to make the movable frame 13 rotatable (swingable) around the second axis (around the X axis in the present embodiment) perpendicular to the first axis.

The first shaft sections 12a, 12b are disposed so as to be opposed to each other via the movable plate 111. Further, the first shaft sections 12a, 12b each have an elongated shape extending in a direction along the Y axis. Further, the first shaft sections 12a, 12b each have one end portion connected to the movable plate 111, and the other end portion connected to the movable frame 13. Further, the first shaft sections 12a, 12b are each disposed so that the center axis and the Y axis coincide with each other. The first shaft sections 12a, 12b configured in such a manner as described above are each torsionally deformed due to the swinging movement of the movable plate 111 around the Y axis.

The second shaft sections 14a, 14b are disposed so as to be opposed to each other via the movable frame 13. Further, the second shaft sections 14a, 14b each have an elongated shape extending in a direction along the X axis. Further, the second shaft sections 14a, 14b each have one end portion connected to the movable frame 13, and the other end portion connected to the outer frame support section 15. The entire second shaft sections 14a, 14b configured in such a manner as described above are each torsionally deformed due to the swinging movement of the movable frame 13 around the X axis. By arranging that the movable plate 111 can swing around the Y axis, and at the same time, the movable frame 13 can swing around the X axis as described above, the swing (rotational) movement around the two axes, namely the X axis and the Y axis, is possible.

It should be noted that the configurations of the first shaft sections 12a, 12b and the second shaft sections 14a, 14b are not limited to the configurations described above. For example, a meander shape having flexion or curvature at least at one place in the middle can also be provided. Further, the number of the first shaft sections 12a, 12b and the second shaft sections 14a, 14b can be singular or plural. It should be noted that the movable plate 111, the movable frame 13, the first shaft sections 12a, 12b, the second shaft sections 14a, 14b, and the outer frame support section 15 are formed integrally using, for example, a silicon single crystal substrate.

As shown in FIG. 8A, the reflecting plate 113 of the reflecting section 4a is formed so as to cover the movable section 2 in the plan view. In other words, the movable plate ill, the first shaft sections 12a, 12b, the movable frame 13, and the second shaft sections 14a, 14b are disposed inside the reflecting plate 113 in the plan view. Therefore, it is possible to increase the area of the reflecting plate 113 while decreasing the distance between the first shaft sections 12a, 12b. Further, since it is possible to decrease the distance between the first shaft sections 12a, 12b, miniaturization of the movable frame 13 can be achieved. Further, since the miniaturization of the movable frame 13 can be achieved, it is possible to decrease the distance between the second shaft sections 14a, 14b. Thus, it becomes possible to miniaturize the overall structure of the light scanner 1c while keeping the area of the reflecting plate 113 large. Further, it is possible to prevent unwanted light from being reflected by the movable plate 111, the first shaft sections 12a, 12b, the movable frame 13, and the second shaft sections 14a, 14b and from becoming the stray light. Further, it is preferable that an antireflection treatment is provided to the surface of the outer frame support section 15. Thus, it is possible to prevent the unwanted light applied to the outer frame support section 15 from becoming the stray light. Such an antireflection treatment is not particularly limited, but there can be cited, for example, formation of an antireflection film (a dielectric multilayer film), a surface roughening process, and a blackening process. It should be noted that the antireflection treatment can also be provided to the surfaces of the movable plate 111, the first shaft sections 12a, 12b, the movable frame 13, and the second shaft sections 14a, 14b besides the outer frame support section 15.

The permanent magnet 21a is disposed so as to be opposed to the surface of the movable plate 111 on the opposite side to the surface fixed to the support rod 115. The permanent magnet 21a has an elongated shape, and is bonded to one surface of the movable frame 13 via the spacer 80. An adhesive or the like is applied to the bonding between the movable frame 13 and the spacer 80, and the bonding between the spacer 80 and the permanent magnet 21a. By making the spacer 80 intervening between the movable frame 13 and the permanent magnet 21a, a space is formed between the movable plate 111 and the permanent magnet 21a. Further, due to the formation of the space, it is possible to prevent the interference between the movable plate 111 and the permanent magnet 21a when swinging the movable plate 111.

The coil 31 is disposed below the permanent magnet 21a. In other words, the coil 31 is disposed so as to be opposed to the permanent magnet 21a. In the present embodiment, the coil 31 is wound around the outer circumference of the magnetic core 32. Further, the coil 31 is electrically connected to the voltage applying section 40. It should be noted that since the configuration of the voltage applying section 40 is substantially the same as in the second embodiment, the explanation of the voltage applying section 40 will be omitted (see FIGS. 4, 5A, and 5B).

Then, an action of the light scanner 1c will be explained. It should be noted that as shown in FIGS. 4, 5A, and 5B, in the present embodiment, the frequency of the first voltage V1 is set to be equal to the torsional resonance frequency of the first vibration system, and the frequency of the second voltage V2 is set to a value, which is different from the torsional resonance frequency of the second vibration system, and is lower than the frequency of the first voltage V1 (e.g., the frequency of the first voltage V1 is set to 15 kHz, and the frequency of the second voltage V2 is set to 60 Hz).

Firstly, for example, the first voltage V1 shown in FIG. 5A and the second voltage V2 shown in FIG. 5B are combined in the voltage combination section 43, and then, the voltage thus combined is applied to the coil 31. Then, the current flows through the coil 31 due to the first voltage V1 applied to the coil 31. As a result, due to the Lorentz force caused by the interaction between the magnetic field by the current flowing through the coil 31 and the magnetic field of the permanent magnet 21a, the first shaft sections 12a, 12b are torsionally deformed, and thus, the movable plate 111 swings taking the Y axis (the first axis) as the center axis. Further, the frequency of the first voltage V1 is equal to the torsional resonance frequency of the first vibration system. Therefore, the movable plate 111 can efficiently be rotated around the Y axis using the first voltage V1. Therefore, even in the case in which the vibration having the torsional vibration component of the movable frame 13 around the Y axis described above is small, the rotational angle of the movable plate 111 around the Y axis due to the vibration can be increased.

Further, the current flows through the coil 31 due to the second voltage V2 applied to the coil 31. As a result, due to the Lorentz force caused by the interaction between the magnetic field by the current flowing through the coil 31 and the magnetic field of the permanent magnet 21a, the second shaft sections 14a, 14b torsionally deformed, and thus, the movable frame 13 swings together with the movable plate 111 taking the X axis (the second axis) as the center axis. Further, the frequency of the second voltage V2 is set to be extremely low compared to the frequency of the first voltage V1. Further, the torsional resonance frequency of the second vibration system is designed to be lower than the torsional resonance frequency of the first vibration system. Therefore, the movable plate 111 can be prevented from rotating around the Y axis at the frequency of the second voltage V2.

It should be noted that in the present embodiment, there is described the so-called moving-magnet actuator having the permanent magnet 21a disposed on the movable frame 13. However, the configuration is not limited thereto, but a so-called moving-coil actuator having the coil disposed on the movable frame 13 can also be adopted. Further, in the moving-coil actuator, the coil can be disposed only on the movable frame 13, or can be disposed on both of the movable frame 13 and the movable plate 111.

As described hereinabove, according to the fourth embodiment described above, the following advantage can be obtained in addition to the advantage of the third embodiment.

When swinging around the first shaft sections 12a, 12b and the second shaft sections 14a, 14b, the deflection of the reflecting plate 113 can be suppressed by the ribs 120c disposed on the second surface 113b of the reflecting plate 113. Thus, it is possible to make the reflecting section 4a act stably.

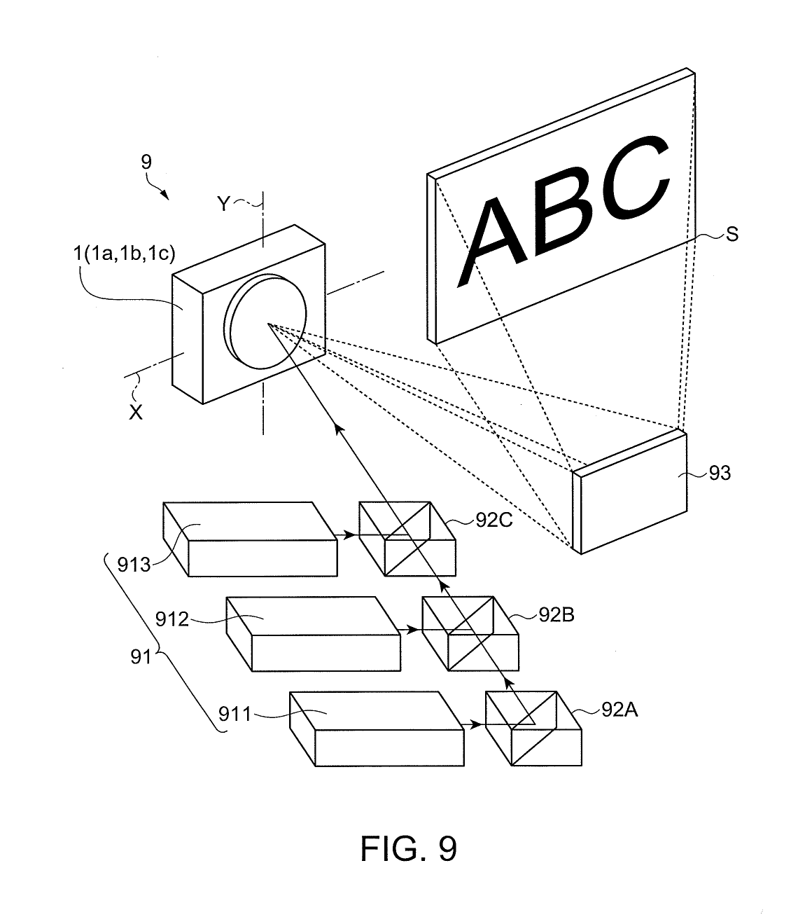

Then, a configuration of an image display device will be explained. The image display device is provided with an actuator and an irradiation section for irradiating the actuator with light, wherein the actuator has a movable section, a first shaft section, and a reflecting section. The first shaft section supports the movable section swingably around a first axis. The reflecting section is provided with a reflecting plate and a support rod. The reflecting plate has a reflecting surface. The support rot is disposed on a surface of the reflecting plate, and the surface is located on an opposite side to the reflecting surface. The support rod is fixed to the movable section. The surface of the reflecting plate on the opposite side to the reflecting surface is provided with at least one rib. FIG. 9 is a schematic diagram showing a configuration of the image display device. Hereinafter, the specific explanation will be presented. It should be noted that in the present embodiment, the case of using the light scanner 1 (1a, 1b, 1c) described above as an actuator will be explained.

As shown in FIG. 9, the image display device 9 is provided with the light scanner 1, 1a, 1b, and 1c, the irradiation section 91, and so on, wherein the irradiation section 91 irradiates the light scanner 1, 1a, 1b, and 1c with the light. The irradiation section 91 according to the present embodiment is provided with a red light source 911 for emitting red light, a blue light source 912 for emitting blue light, and a green light source 913 for emitting green light. Further, dichroic mirrors 92A, 92B, and 92C are disposed so as to correspond respectively to the red light source 911, the blue light source 912, and the green light source 913.

The dichroic mirrors 92A, 92B, and 92C are optical elements for combining the lights emitted respectively from the red light source 911, the blue light source 912, and the green light source 913. Such an image display device 9 as described above combines the lights emitted from the irradiation section 91 (the red light source 911, the blue light source 912, and the green light source 913) with the dichroic mirrors 92A, 92B, and 92C, respectively, based on the image information from a host computer not shown, and then the light scanner 1, 1a, 1b, and 1c is irradiated with the light thus combined. Further, there is provided a configuration in which scanning of the light scanner 1, 1a, 1b, and 1c is performed to thereby form a color image on a screen S.

In the case of the two-dimensional scanning, the light reflected by the reflecting plate 113 is scanned (main scanning) in a lateral direction of the screen S due to the rotation of the movable plate 111 of the light scanner 1a, 1c around the Y axis. On the other hand, the light reflected by the reflecting plate 113 is scanned (sub-scanning) in a vertical direction of the screen S due to the rotation of the movable plate 111 of the light scanner 1a, 1c around the X axis. It should be noted that although in the present embodiment, there is adopted the configuration in which the light combined by the dichroic mirrors 92A, 92B, and 92C is scanned two-dimensionally by the light scanner 1a, 1c, then the light is reflected by the stationary mirror 93, and then the image is formed on the screen S, it is also possible to adopt the configuration in which the stationary mirror 93 is eliminated, and the screen S is irradiated directly with the light scanned two-dimensionally by the light scanner 1a, 1c.

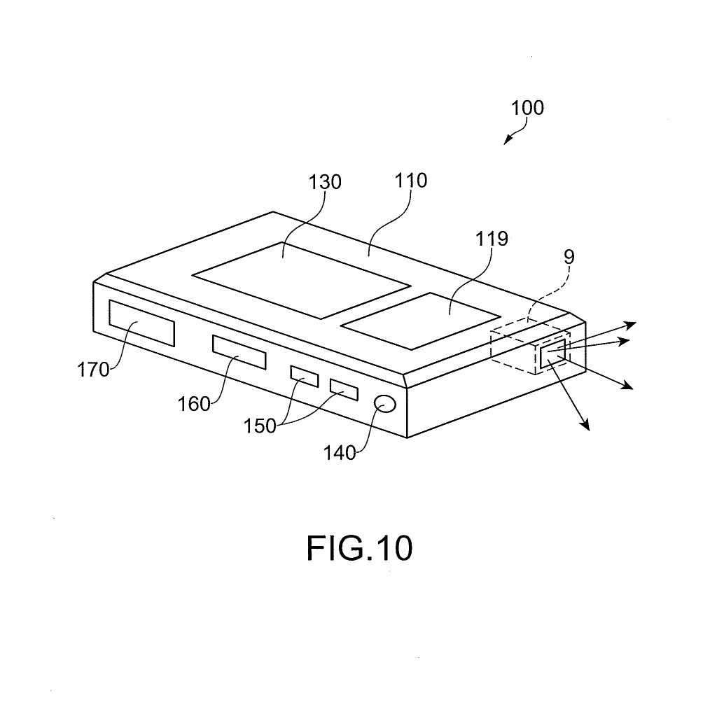

The image display device 9 described above can be applied as, for example, a portable image display device. FIG. 10 is a schematic diagram showing a configuration of the portable image display device. The portable image display device 100 has a casing 110 formed to have a size suitable to be gripped by a hand, and the image display device 9 incorporated in the casing 110. It is possible to display a predetermined image on a predetermined surface such as a screen or a predetermined surface of a desk and so on using the portable image display device 100. Further, the portable image display device 100 has a display 119 for displaying predetermined information, a keypad 130, an audio port 140, control buttons 150, a card slot 160, and an AV port 170. It should be noted that the portable image display device 100 can also be provided with other functions such as a telephone-call function or a GPS receiver function.

Then, a configuration of a head-up display (HUD) will be explained. The head-up display (HUD) is provided with an actuator and an irradiation section for irradiating a light scanner with light, wherein the actuator has a movable section, a first shaft section, and a reflecting section. The first shaft section supports the movable section swingably around a first axis. The reflecting section is provided with a reflecting plate and a support rod. The reflecting plate has a reflecting surface. The support rot is disposed on a surface of the reflecting plate, and the surface is located on an opposite side to the reflecting surface. The support rod is fixed to the movable section. The surface of the reflecting section on the opposite side to the reflecting surface is provided with at least one rib. It should be noted that in the present embodiment, the case of using either of the light scanners 1, 1a, 1b, and 1c described above as the actuator will be explained.

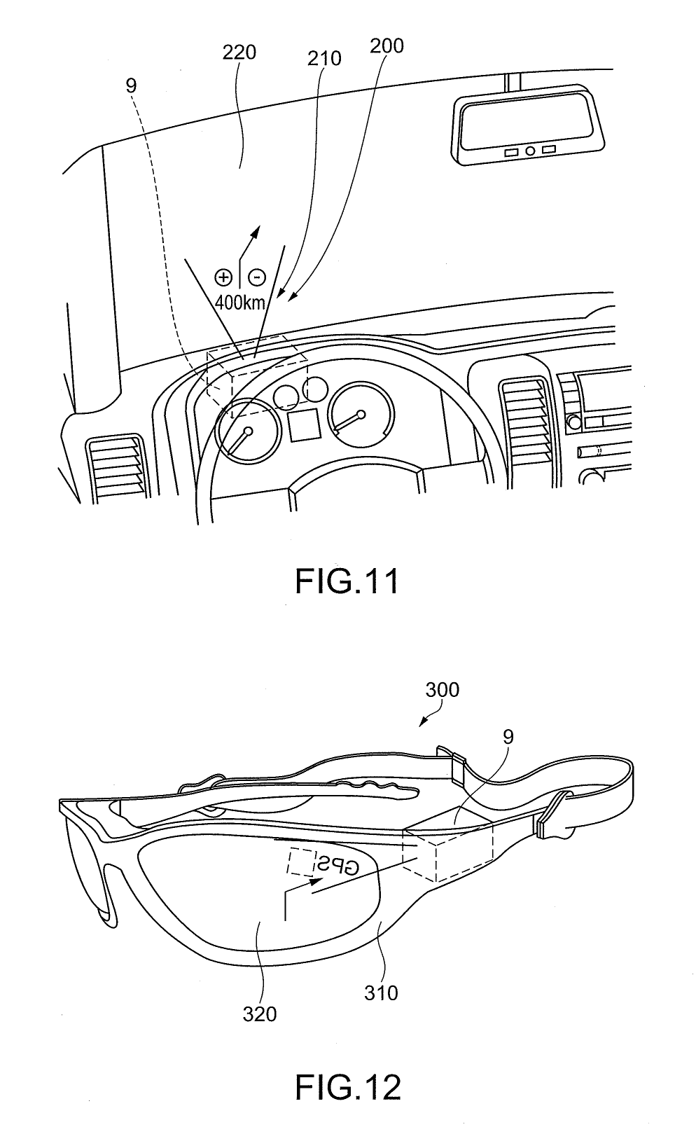

FIG. 11 is a schematic diagram showing a configuration of the head-up display (HUD). As shown in FIG. 11, the head-up display (HUD) 210 is equipped with the image display device 9 provided with the light scanner 1 (1a through 1c) described above. Further, in a head-up display system 200, the image display device 9 is installed in, for example, a dashboard of a vehicle so as to constitute the head-up display 210. A predetermined image such as a guide display to the destination can be displayed on a front glass 220 using the head-up display 210. It should be noted that the head-up display system 200 can also be applied to, for example, an aircraft and a ship besides a vehicle.

Then, a configuration of a head mounted display (HMD) will be explained. The head mounted display is provided with an actuator and an irradiation section for irradiating a light scanner with light, wherein the actuator has a movable section, a first shaft section, and a reflecting section. The first shaft section supports the movable section swingably around a first axis. The reflecting section is provided with a reflecting plate and a support rod. The reflecting plate has a reflecting surface. The support rot is disposed on a surface of the reflecting plate, and the surface is located on an opposite side to the reflecting surface. The support rod is fixed to the movable section. The surface of the reflecting plate on the opposite side to the reflecting surface is provided with at least one rib. It should be noted that in the present embodiment, the case of using either of the light scanners 1, 1a, 1b, and 1c described above as the actuator will be explained.

FIG. 12 is a schematic diagram showing a configuration of the head mounted display (HMD). As shown in FIG. 12, the head mounted display (HMD) 300 is equipped with the image display device 9 provided with the light scanner 1 (1a through 1c) described above. The head mounted display 300 is provided with a spectacle type frame section 310, and the image display device 9 is disposed on the frame section 310. Further, the head mounted display 300 displays a predetermined image to be visually recognized by one of the eyes on a display section 320 disposed at a region of the frame section 310 where a lens is normally disposed using the image display device 9.

The display section 320 can be transparent, or opaque. In the case in which the display section 320 is transparent, it is possible to use the information from the image display device 9 overlapping the information from the actual world. It should be noted that it is also possible to provide two image display devices 9 to the head mounted display 300 to thereby arrange that the images to be visually recognized respectively by both of the eyes are displayed on the two display sections 320.

Although the configurations of the light scanner as the actuator, the image display device, and so on are explained hereinabove, the configurations are not limited thereto. For example, the configuration of each section can be replaced with an arbitrary configuration having substantially the same function, and further, it is also possible to add an arbitrary constituent. Further, the invention can be one obtained by combining any two or more configurations (features) of the embodiments described above.

It should be noted that the invention is not limited to the embodiments described above, but various modifications or improvements can be provided to the embodiments described above. Some modified examples will be described below.

### MODIFIED EXAMPLE 1

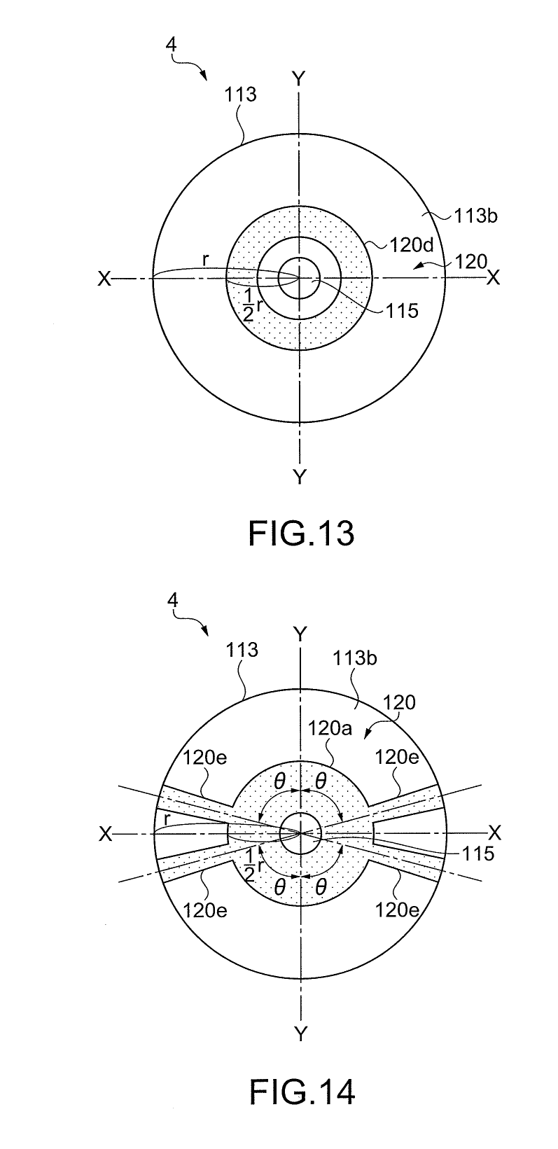

Although in the first and second embodiments, the rib 120a having a circular shape having contact with the support rod 115 is disposed on the second surface 113b of the reflecting plate 113, the invention is not limited to this configuration. FIG. 13 is a plan view of a reflecting section according to a modified example 1. As shown in FIG. 13, it is also possible to dispose a rib 120d having a circular shape (a doughnut shape) on the second surface 113b so as not to have contact with the support rod 115. According also to this configuration, substantially the same advantages as in the embodiments described above can be obtained.

### MODIFIED EXAMPLE 2

Although in the first and second embodiments, the ribs 120b each extending from the area within a half of the radius r of the reflecting plate 133 toward the outer circumferential portion of the reflecting plate 113 at the angle θ=45° with the swing axis (the Y axis) are disposed, the invention is not limited to this configuration. FIG. 14 is a plan view of a reflecting section according to a modified example 2. As shown in FIG. 14, it is also possible to dispose the rib 120a disposed in the area within a half of the radius r of the reflecting plate 113, and the ribs 120e each extending from the area within a half of the radius r of the reflecting plate 113 toward the outer circumferential portion of the reflecting plate 113 at the angle θ=75° with the swing axis (the Y axis). According also to this configuration, substantially the same advantages as in the embodiments described above can be obtained.

### MODIFIED EXAMPLE 3

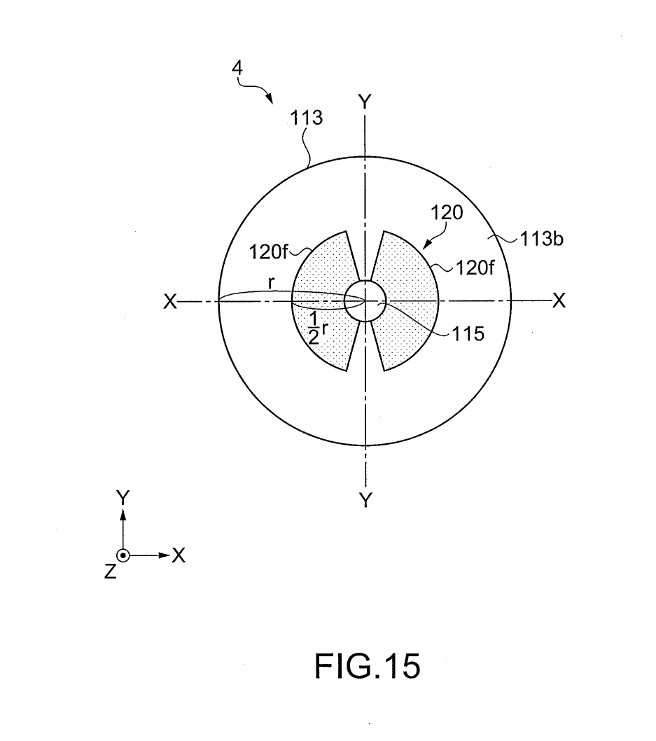

Although in the third and fourth embodiments, the ribs 120c each having a fan-like shape including a circular arc are disposed on the second surface 113b of the reflecting plate 113 at the position not having contact with the support rod 115, the invention is not limited to this configuration. FIG. 15 is a plan view of a reflecting section according to a modified example 3. As shown in FIG. 15, it is also possible to dispose ribs 120f each having a fan-like shape on the second surface 113b so as to have contact with the support rod 115. According also to this configuration, substantially the same advantages as in the embodiments described above can be obtained.

### MODIFIED EXAMPLE 4

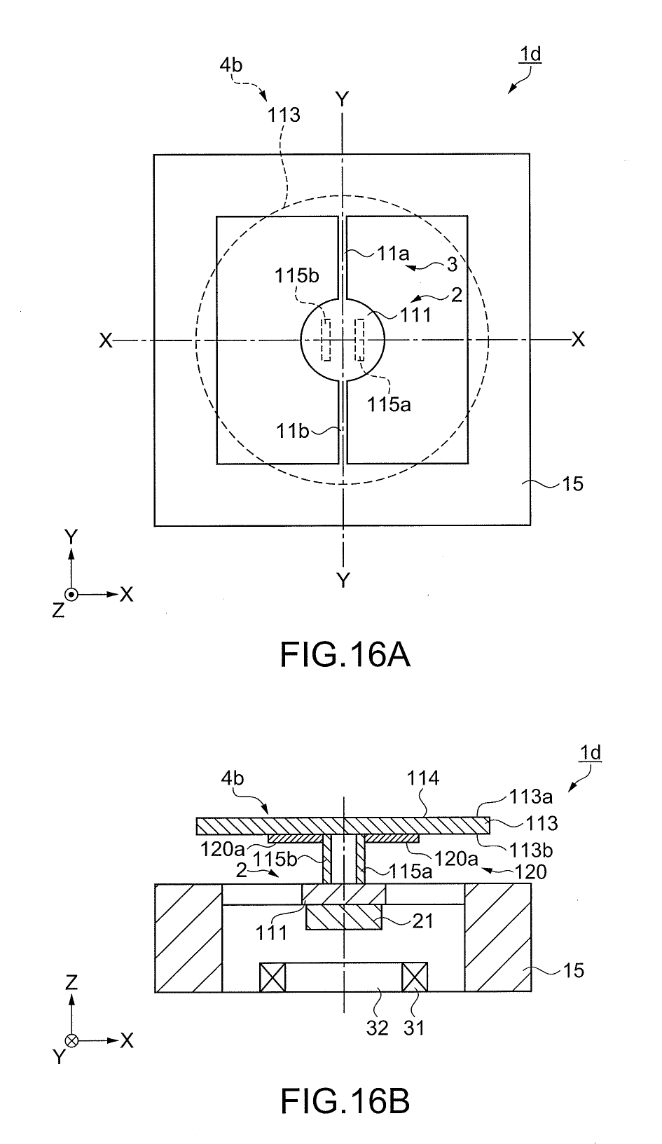

Although in the first through fourth embodiments, a single support rod 115 is disposed in the reflecting section 4, 4a, the invention is not limited to this configuration. FIGS. 16A and 16B are schematic diagrams showing a configuration of a light scanner according to a modified example 4. The light scanner 1d can also have a plurality of support rods 115a. For example, as shown in FIGS. 16A and 16B, it is also possible to configure a reflecting section 4b having two support rods 115a, 115b disposed so as to avoid the center of the reflecting plate 113. In this case, the two support rods 115a are formed so as to be disposed in an area except the area on the Y-axis line (the shaft sections 11a, 11b) to be the first axis. According also to such a configuration as described above, substantially the same advantages as described above can be obtained, and at the same time, it is possible to prevent the adhesive, which runs off when pressing the support rods 115a and the movable plate 111 against each other for bonding the support rods 115a and the movable plate 111 to each other, from adhering to the shaft sections 11a, 11b to thereby keep the swing drive efficiency. It should be noted that it is also possible to install the light scanner 1d having the reflecting section 4b to the image display device 9, the head mounted display 300, and so on as shown in FIGS. 9 through 12. According also to this configuration, substantially the same advantages as in the embodiments described above can be obtained.

The entire disclosure of Japanese Patent Application No. 2012-279066, filed Dec. 21, 2012 is expressly incorporated by reference herein.

What is claimed is:

1. An actuator comprising:
a movable section;
a first shaft section adapted to swingably support the movable section around a first axis; and
a reflecting section including a reflecting plate having a reflecting surface adapted to reflect light, and a support rod disposed on a surface of the reflecting plate on an opposite side to the reflecting surface, the support rod being fixed to the movable section,
wherein a rib is provided to the surface of the reflecting plate on the opposite side to the reflecting surface.

2. The actuator according to claim 1, wherein
the rib has a circular shape centered on the support rod.

3. The actuator according to claim 1, wherein
the rib has a fan-like shape including a circular arc centered on the support rod.

4. The actuator according to claim 2, wherein
the reflecting plate has a circular shape in a plan view, and
the rib is disposed in an area within a half of a radius of the reflecting plate from a center of the support rod on the surface of the reflecting plate on the opposite side to the reflecting surface.

5. The actuator according to claim 4, further comprising:
a rib extending from the area within a half of the radius of the reflecting plate toward an outer circumferential portion of the reflecting plate.

6. The actuator according to claim 1, wherein
the rib is disposed symmetrically about the first axis in a plan view from a through-thickness direction of the reflecting plate.

7. The actuator according to claim 1, further comprising:
a movable frame connected to the first shaft section, and having a frame-like shape surrounding the movable section; and
a second shaft section adapted to swingably support the movable frame around a second axis intersecting with the first axis.

8. An image display device comprising:
an actuator including
a movable section,
a first shaft section adapted to swingably support the movable section around a first axis, and
a reflecting section including a reflecting plate having a reflecting surface adapted to reflect light, and a support rod disposed on a surface of the reflecting plate on an opposite side to the reflecting surface, the support rod being fixed to the movable section,
wherein a rib is provided to the surface of the reflecting plate on the opposite side to the reflecting surface; and
an irradiation section adapted to irradiate the actuator with the light.

9. A head mounted display comprising:
an actuator including
a movable section,
a first shaft section adapted to swingably support the movable section around a first axis, and
a reflecting section including a reflecting plate having a reflecting surface adapted to reflect light, and a support rod disposed on a surface of the reflecting plate on an opposite side to the reflecting surface, the support rod being fixed to the movable section,
wherein a rib is provided to the surface of the reflecting plate on the opposite side to the reflecting surface; and
an irradiation section adapted to irradiate the actuator with the light.
